(19) United States
(12) Patent Application Publication
(10) Pub. No.: US 2006/0147671 A1
(43) Pub. Date: Jul. 6, 2006

(54) Banding apparatus and method of manufacture

(76) Inventors: Peter F. Bemis, Elkhart Lake, WI (US); Daniel Cykana, Hingham, WI (US); Einar Anderson, Maribel, WI (US)

Correspondence Address: MICHAEL BEST & FRIEDRICH, LLP, 100 E WISCONSIN AVENUE, MILWAUKEE, WI, 53202, US

(21) Appl. No.: 11/286,594

(22) Filed: Nov. 23, 2005

Related U.S. Application Data
(60) Provisional application No. 60/630,373, filed on Nov. 23, 2004.

(51) Int. Cl. B32B 3/06

(52) U.S. Cl. 428/99; 428/212

(57) ABSTRACT

A banding apparatus for a furniture element, and a method of manufacturing a banding apparatus. The furniture element can include a recess and an external surface. The banding apparatus can include a first portion dimensioned to cover the external surface of the furniture element, and a second portion coupled to the first portion and dimensioned to be received with the recess of the furniture element. The first portion can include an olefinic elastomer or a first thermoplastic polyolefin elastomer having a first ratio of a first polyolefin to a first olefinic elastomer. The second portion can include a second thermoplastic polyolefin elastomer having a second ratio of a second polyolefin to a second olefinic elastomer. A method of manufacturing a banding apparatus can include co-extruding a first elastomer and a second elastomer to form the first portion and the second portion, respectively.

### RELATED APPLICATIONS

Priority is hereby claimed to U.S. Provisional Patent Application No. 60/630,373, filed Nov. 23, 2004, the entire contents of which are incorporated herein by reference.

### BACKGROUND

Some conventional banding apparatuses, which can be used in a variety of applications in the office furniture industry (e.g., an edging for desktops) are formed of polyvinyl chloride (PVC). PVC is a useful material for such banding apparatuses. However, PVC emits hazardous chlorine gas into the atmosphere upon burning, and therefore, is not environmentally friendly or recyclable.

### SUMMARY

Some embodiments of the present invention provide a banding apparatus for use with a furniture element having a recess and an external surface. The banding apparatus can include a first portion dimensioned to cover the external surface of the furniture element, and a second portion coupled to the first portion and dimensioned to be received with the recess of the furniture element. The first portion can include a first thermoplastic polyolefin elastomer having a first ratio of a first polyolefin to a first olefinic elastomer. The second portion can include a second thermoplastic polyolefin elastomer having a second ratio of a second polyolefin to a second olefinic elastomer. The second ratio can be different from the first ratio.

In some embodiments of the present invention, a banding apparatus for use with a furniture element having a recess and an external surface is provided. The banding apparatus can include a first portion dimensioned to cover the external surface of the furniture element, and a second portion coupled to the first portion and dimensioned to be received within the recess of the furniture element to couple the banding apparatus to the furniture element. The first portion can include at least one of an olefinic elastomer and a first thermoplastic olefin elastomer. The second portion can include a second thermoplastic olefin elastomer, the second portion being harder than the first portion.

Some embodiments of the present invention provide a method of manufacturing a banding apparatus for a furniture element having a recess and an external surface. The method can include extruding a first elastomer to form a first portion of the banding apparatus, and co-extruding a second elastomer with the first elastomer to form a second portion of the banding apparatus. The first portion can be adapted to cover the external surface of the furniture element, and the second portion can be dimensioned to be received within the recess of the furniture element. The second elastomer can be different from the first elastomer.

Other features and aspects of the invention will become apparent by consideration of the detailed description and accompanying drawings.

### BRIEF DESCRIPTION OF THE DRAWINGS

FIG. 1 illustrates a cross-sectional exploded view of a banding apparatus according to one embodiment of the present invention.

FIG. 2 illustrates the banding apparatus of FIG. 1 coupled to a furniture element.

FIG. 3 illustrates a cross-sectional assembled view of a banding apparatus according to another embodiment of the present invention.

FIG. 4 illustrates a cross-sectional assembled view of a banding apparatus according to another embodiment of the present invention.

FIG. 5 illustrates a cross-sectional assembled view of a banding apparatus according to another embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Furthermore, terms such as “front,” “rear,” “top,” “bottom,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

The present invention is generally directed to a banding apparatus. In some embodiments, the banding apparatus includes a first portion for coupling with a furniture element, and a second portion for providing impact resistance and aesthetics to the furniture element. The present invention is further directed to a method of manufacturing a banding apparatus.

As used herein, the term “furniture element” refers to any portion of a piece of furniture. As used herein, the term “furniture” can include, without limitation, at least one of tabletops, countertops, conference tables, desktops, shelves, bookcases, packing stands, credenzas, file cabinets, bookcase cabinets, drawers, and combinations thereof.

As used herein, the term “olefin” refers to any unsaturated open-chain hydrocarbons having the general formula CₙH₂ₙ (i.e., an alkene with one carbon-carbon double bond) including, without limitation, ethylene, propylene, butene, pentene, hexene, heptene, octene, etc.

As used herein, the term “polymer” or “polymeric material” refers to a substance made of many repeating chemical units or molecules, namely, monomers. Polymers can comprise thermoplastic polymers (or “thermoplastics”), thermoset polymers (or “thermosets”), and combinations thereof. Thermoplastic polymers soften when heated or reheated and harden or become firm on cooling. Thermoset polymers can be hardened or set by at least one of heat, chemical cross-linking techniques, or radiation cross-linking techniques, and once set, cannot be resoftened by heating (i.e., difficult to reprocess or recycle).

As used herein, the term “elastomer” refers to any polymeric material that may experience reversible elastic deformations. Elastomers can comprise at least one of thermoplastic elastomers (or rubbers) and thermoset elastomers (or rubbers), and combinations thereof.

As used herein, the term “thermoset elastomer” refers to an elastomer that is difficult to reprocess or recycle.

As used herein, the term “thermoplastic elastomer” refers to a diverse family of elastomers that, unlike conventional thermoset elastomers, can be reprocessed or recycled like thermoplastic materials.

As used herein, the term “olefinic elastomers” can refer to an elastomer comprising an olefin and can include, without limitation, ethylene-propylene rubber (EPR), ethylene-butene rubber (EBR), ethylene-octene rubber (EOR), ethylene-propylene-diene terpolymer (EPDM), etc., and combinations thereof. The olefinic elastomers can each include at least one of a thermoset elastomer or rubber (TSR) and a thermoplastic elastomer or rubber (TPR), and combinations thereof.

As used herein, the term “thermoplastic polyolefinic elastomers” refers to a member of the thermoplastic elastomer family and are commonly referred to as “TPO.” Thermoplastic polyolefinic elastomers can include blends of polyolefins and olefinic elastomers. Polyolefins can include olefinic homopolymers, olefinic copolymers, and combinations thereof.

As used herein, the term “homopolymer” refers to a nominally linear chain (but often with some branching) of many hundreds or thousands of one specific monomer.

As used herein, the term “copolymer” refers to a polymer formed of two or more different monomers. Some copolymers comprise two different monomers mixed together before being polymerized, such that the resulting chain will have the different monomers distributed randomly, or in an alternating fashion, along its length. Some copolymers comprise individual monomers that are each polymerized to form short chains that are then mixed together and further polymerized so that the final polymer has a block distribution of each monomer (i.e., sometimes referred to as a “block copolymer”), rather than a random or alternating distribution, or blends of polymerized materials that are blended and melted together during processing.

As used herein, the term “additive” refers to any substance that can be added to another in relatively small amounts to change properties, and can include, without limitation, antioxidants, ultraviolet (UV) absorbers, UV inhibitors, antistatic agents, flame retardants, pigments, dyes, colorants, etc., and combinations thereof.

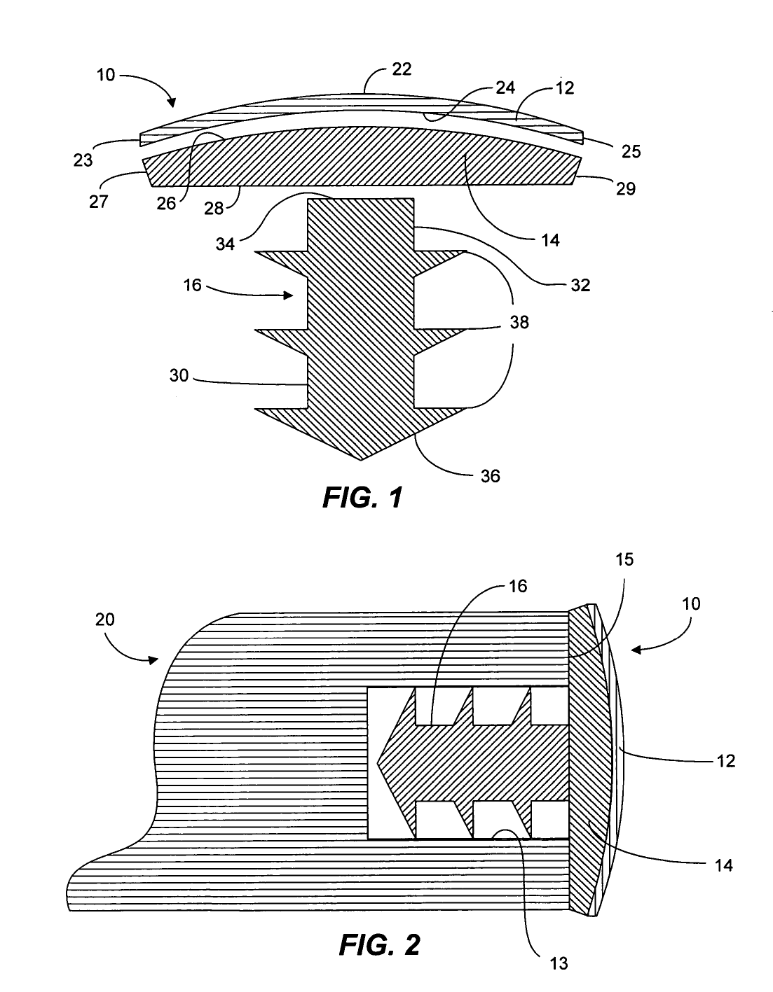

FIG. 1 illustrates a banding apparatus 10 according to one embodiment of the present invention. FIG. 2 illustrates the banding apparatus 10 coupled to a furniture element 20. As illustrated in FIGS. 1 and 2, the banding apparatus 10 includes an outer cover 12, an inner support 14, and a coupling member 16 which couples the banding apparatus 10 to the furniture element 20.

As shown in FIG. 2, the furniture element includes a recess 13 and an external surface 15. The coupling member 16 is dimensioned to be received within the recess 13 of the furniture element 20 to couple the banding apparatus 10 with the furniture element 20. The outer cover 12 and the inner support 14 are dimensioned to cover the external surface 15 of the furniture element 20 to provide protection (e.g., scratch resistance, shock absorbance, impact resistance, toughness, etc.) and aesthetics to the furniture element 20.

The shape and relative dimensions of the banding apparatus 10 and the furniture element 20 are shown in FIG. 2 by way of example only. It should be understood to one of ordinary skill in the art, however, that the banding apparatus 10 and the furniture element 20 can have other shapes and dimensions without departing from the spirit and scope of the present invention. In addition, the entire coupling member 16 need not be received within the recess 13. Furthermore, the external surface 15 does not necessarily include the entire external surface of the furniture element 20, but rather a relevant portion thereof. Thus, the outer cover 12 and inner support 14 need not cover an entire external surface of the furniture element 20, but rather a portion thereof (i.e., the external surface 15 refers only to one external surface of the furniture element 20). For example, the outer cover 12 and the inner support 14 may cover an external surface 15 of a furniture element that will be visible and accessible in normal, daily use of the furniture element 20 to impart the above properties to the external surface 15 of the furniture element 20.

The outer cover 12 can comprise one or more polymers. In some embodiments, the polymer can comprise an elastomer, such as an olefin elastomer (e.g., an ethylene elastomer). In some embodiments, the polymer can comprise a thermoplastic elastomer, such as a TPO (e.g., a TPO wherein the polyolefin comprises polypropylene, a TPO wherein the polyolefin comprises a copolymer of polypropylene and polyethylene, a TPO with a UV inhibitor additive, and combinations thereof). The olefin elastomer of the outer cover 12 can be formulated to allow the outer cover 12 to be at least one of aesthetically pleasing, flexible, capable of being easily manufactured (e.g., by extrusion), capable of being easily cleaned, stain resistant, abrasion resistant, and at least partially impact-resistant. The outer cover 12 is generally more flexible than the inner support 14 or the coupling member 16.

In some embodiments, the outer cover 12 is colored or otherwise modified (e.g., with one or more additives) to provide aesthetics to the banding apparatus 10 (e.g., color coordination with the surrounding environment or other office components, if used in an office setting). In some embodiments, the outer cover 12 is the only colored portion of the banding apparatus 10. Accordingly, in such embodiments, processing color changes can be accomplished relatively quickly, because only the outer cover 12 is changed over to a new color. In some embodiments, the inner support 14 can also be colored. In some embodiments, the inner support 14 is colored the same as the outer cover 12, but with a less expensive colorant. In some embodiments, a carrier for a colorant is added to the material used to form one or more of the outer cover 12, the inner support 14, and the coupling member 16. The carrier can include a variety of materials including, without limitation, a fatty acid, such as sorbitan trioleate (STO).

The outer cover 12 can be flat or curved, depending on the shape of the furniture element 20 to which the banding apparatus 10 is coupled. The outer cover 12 includes an outer, or external, surface 22 and an inner, or internal, surface 24. In the embodiment illustrated in FIGS. 1 and 2, the outer surface 22 and the inner surface 24 of the outer cover 12 are curved, and the outer cover 12 is uniformly thick from a first end 23 to a second end 25. In other embodiments, the outer cover 12 is thicker in the middle and tapers toward one or both of the first end 23 and the second end 25.

The inner support 14 includes an outer, or external, surface 26 and an inner, or internal, surface 28. As illustrated in FIGS. 1 and 2, the inner surface 24 of the outer cover 12 is coupled to the outer surface 26 of the inner support 14. The outer surface 26 of the inner support 14 can be flat or curved, and can be shaped to fit adjacent the inner surface 24 of the outer cover 12. In the embodiment illustrated in FIGS. 1 and 2, the outer surface 26 of the inner support 14 is curved to match the curve of the inner surface 24 of the outer cover 12. Similarly, the inner surface 28 can be flat or curved. In the embodiment illustrated in FIGS. 1 and 2, the inner surface 28 is flat, and the inner support 14 tapers in thickness from a first end 27 to a second end 29. In other embodiments, the inner support 14 is uniformly thick from the first end 27 to the second end 29.

The inner support 14 can comprise one or more polymers, particularly, one or more elastomers, and more particularly, one or more thermoplastic elastomers, such as a TPO. For example, the inner support 14 can comprise a blend of (a) a polyolefin, such as an olefinic homopolymer or copolymer (e.g., a homopolymer of polypropylene, a copolymer of polypropylene and polyethylene, etc.), and (b) an olefinic elastomer. In some embodiments, the olefinic elastomer includes at least one of ethylene butene rubber and ethylene octene rubber. Ethylene butene rubber and ethylene octene rubber can each include at least one of a thermoset rubber (TSR) and a thermoplastic rubber (TPR).

The coupling member 16 is generally elongated with a top side 30 and a bottom side 32. The coupling member 16 of the embodiment illustrated in FIGS. 1 and 2 is located approximately in the symmetrical center of the inner support 14 and the outer cover 12. However, in other embodiments, the coupling member 16 is not symmetrically centered relative to the inner support 14 and the outer cover 12.

The coupling member 16 further includes a flat end 34 that is positioned adjacent the inner surface 28 of the inner support 14 and a tapered end 36 disposed a distance from the flat end 34. The tapered end 36 is illustrated in FIGS. 1 and 2 as coming to point. However, one of ordinary skill in the art will appreciate that the tapered end 36 can instead be rounded, or have any other shape desired.

The coupling member 16 includes a plurality of projections 38 that extend outwardly from one or both of the top side 30 and the bottom side 32 to couple the coupling member 16 (and therefore, the banding apparatus 10) to the furniture element 20. The embodiment illustrated in FIGS. 1 and 2 includes three projections 38 that extend outwardly from both the top side 30 and the bottom side 32 at approximately 90° from the longitudinal axis of the coupling member 16. One of ordinary skill in the art will appreciate that more or fewer than three projections 38 can be used, the projections 38 can extend outwardly from the top and bottom sides 30, 32 of the coupling member 16 at angles other than 90°, and that the number of projections 38 that extend from the top side 30 do not need to equal the number of projections 38 that extend from the bottom side 32. In some embodiments, the projections 38 are shaped to inhibit disengagement of the coupling member 16 (and the banding apparatus 10) from the furniture element 20.

The coupling member 16 can comprise one or more polymers, particularly, one or more elastomers, and more particularly, one or more thermoplastic elastomers, such as a TPO, similar to those of the inner support 14. However, in embodiments employing a TPO, the constituent materials can be blended in a manner to impart different physical properties. For example, the coupling member 16 can include a smaller percentage of the olefinic elastomer to increase the stiffness and hardness of the coupling member 16 relative to the inner support 14. The coupling member 16 is generally stiffer (i.e., has a higher Young's modulus), less tough, and harder (e.g., has a higher Shore A Durometer Hardness) than the inner support 14. As a result, the inner support 14 can be more shock-absorbent, and the coupling member 16 can be more capable of maintaining engagement with the furniture element 20. In some embodiments, the coupling member 16 can comprise recycled materials, and in some embodiments, the coupling member 16 is hidden from view when the banding apparatus 10 is engaged with the furniture element 20.

The chemical formulation of each of the outer cover 12, the inner support 14 and the coupling member 16 can be changed, depending on the application of the banding apparatus 10. Specifically, the ratio of the polyolefin to the olefinic elastomer can be adjusted to meet the mechanical and aesthetic property requirements of an application. A variety of ratios can be used to provide the necessary mechanical and aesthetic properties, including relative properties, for each of the outer cover 12, the inner support 14 and the coupling member 16. For example, one or more of the outer cover 12, the inner support 14 and the coupling member 16 can include at least about 15% polyolefin (i.e., 15/85, which refers to about 15% polyolefin to about 85% olefinic elastomer), particularly, at least about 20% polyolefin (i.e., 20/80), and more particularly, at least about 25% polyolefin (i.e., 25/75). In addition, one or more of the outer cover 12, the inner support 14 and the coupling member 16 can include less than about 55% polyolefin (i.e., 55/45), particularly, less than about 50% polyolefin (i.e., 50/50), and more particularly, less than about 45% polyolefin (i.e., 45/55).

The relative properties of each of the outer cover 12, the inner support 14 and the coupling member 16 can be varied to meet the specific needs for each portion. For example, one or both of the outer cover 12 and the inner support 14 can provide at least one of a soft touch, a tactile feel, impact resistance, scratch or mar resistance, and slip resistance to the portion of the banding apparatus 10 that covers the external surface 15 of the furniture element 20. The coupling member 16, on the other hand, can be harder, stiffer, and can have an increased dimensional stability compared to either of the outer cover 12 and the inner support 14 to maintain engagement between the coupling member 16 and the furniture element 20. In some embodiments, for example, the Shore A Durometer hardness for the outer cover 12 and/or the inner support 14 can be at least about 10, particularly, at least about 20, and more particularly, at least about 30. In addition, the Shore A Durometer hardness for the outer cover 12 and/or the inner support 14 can be less than about 80, particularly, less than about 50, and more particularly, less than about 40. To achieve the desired tactile feel of the portion of the banding apparatus 10 that covers the external surface 15 of the furniture element 20, the Shore A Durometer hardness of the outer cover 12 can be varied, or the Shore A Durometer hardness of the inner support 14 can be varied, or both.

As a result, the material formulation for the outer cover 12, the inner support 14 and/or the coupling member 16 of the banding apparatus 10 can be controlled to achieve a variety of hardness. The hardness of the portions of the banding apparatus 10 are modulated without using any plasticizers. In addition, blending a low-cost commodity polyolefin (e.g., polypropylene) with a more expensive olefinic elastomer (e.g., ENGAGE®-brand ethylene butene, available from Dupont Dow, made using a metalocene catalyst technology) allows for the manufacture of a relatively low-cost banding apparatus 10, as opposed to the relatively high manufacturing cost that might result from manufacturing the part solely out of an olefinic elastomer. The resulting TPO comprising a blend of a polyolefin and an olefinic elastomer can be manufactured at a cost that is closer to that of PVC products, without the environmental concerns.

In addition, the TPOs used to form any portion of the banding apparatus 10 are substantially free of styrene or any styrene derivatives. Furthermore, the TPOs used with the present invention are substantially free of any fibrous materials, and particularly, are substantially free of any mineral fibers.

In some embodiments, more than one polyolefin, and/or more than one olefinic elastomer can be blended to form the inner support 14 or the coupling member 16. In addition, the processing parameters for manufacturing each of the outer cover 12, the inner support 14 and the coupling member 16 can be changed to accommodate a variety of applications.

The banding apparatus 10 can be formed by a variety of molding and extruding processes. In some embodiments, the banding apparatus 10 is co-extruded using three extrusion dies (i.e., a tri-extrudate): one for the outer cover 12, one for the inner support 14, and one for the coupling member 16. In some embodiments, the copolymers used to form the inner support 14 and the coupling member 16 are blended together prior to extrusion. In some embodiments, the tri-extruder includes three adjacent extrusion dies that come together for at least a portion of their length (e.g., at the end of the tri-extruder) to allow the outer cover 12, the inner support 14 and the coupling member 16 to become coupled together (e.g., by the heat and pressure of the extrusion die).

In some embodiments, there is a common constituent in all three of the outer cover 12, the inner support 14 and the coupling member 16 (e.g., ethylene) to allow covalent bonding to occur between the outer cover 12 and the inner support 14, and between the inner support 14 and the coupling member 16. In such embodiments, the covalent bonding between components creates a very durable and securely coupled banding apparatus 10. Such a banding apparatus 10 can easily be coupled to irregularly-shaped furniture elements that require the banding apparatus 10 to at least partially conform to a tortuous path.

In some embodiments, an in-line vacuum calibration system is used to remove heat from the profile of the extruder at an equal rate and allow the completed part to cool without shrinkage or warpage. For example, an in-line vacuum calibration system is described in HT Vacuum Sizing Tanks User Guide, provided by The Conair Group, Inc., which is incorporated herein by reference.

In some embodiments, the banding apparatus 10 does not include an inner support 14. That is, some applications may require a thinner banding apparatus 10, or may not require as much toughness or shock absorption, and the inner support 14 is eliminated. In such embodiments, the outer cover 12 and the coupling member 16 are co-extruded in two extrusion dies.

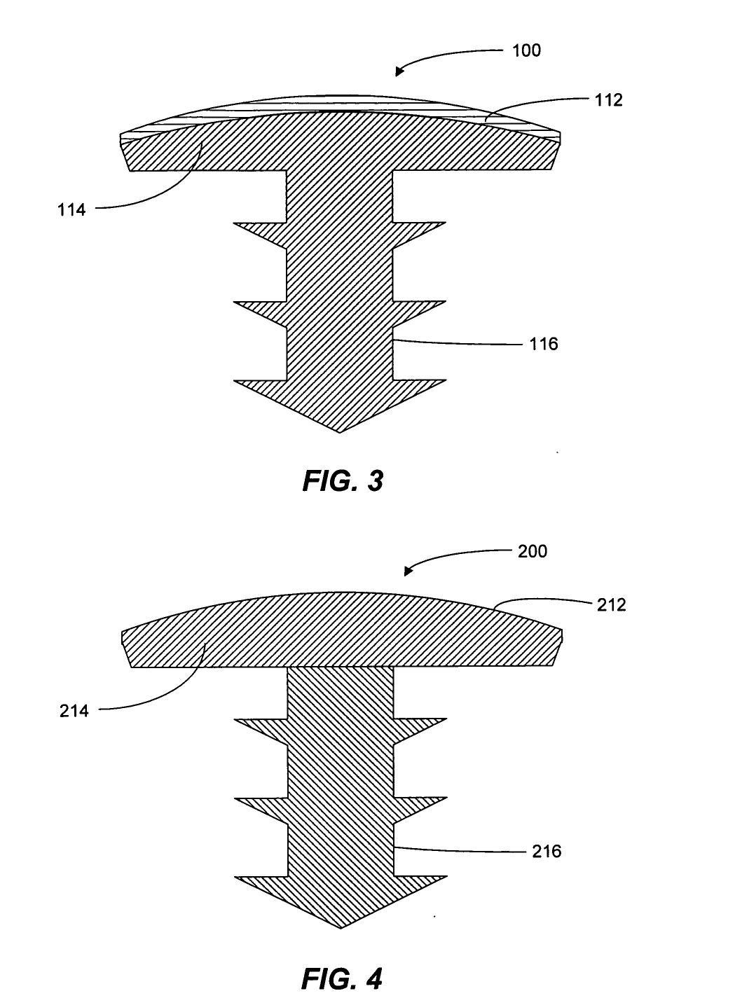

FIG. 3 illustrates a banding apparatus 100 according to another embodiment of the present invention, wherein like numerals represent like elements. The banding apparatus 100 shares many of the same elements and features described above with reference to the illustrated embodiment of FIGS. 1-2. Accordingly, elements and features corresponding to elements and features in the illustrated embodiment of FIGS. 1-2 are provided with the same reference numerals in the 100 series. Reference is made to the description above accompanying FIGS. 1-2 for a more complete description of the features and elements (and alternatives to such features and elements) of the embodiment illustrated in FIG. 3.

The banding apparatus 100 includes an outer cover 112, an inner support 114, and a coupling member 116, which couples the banding apparatus 100 to a furniture element, such as the furniture element 20 illustrated in FIG. 2. The outer cover 112 comprises a first material, such as a polymer or an elastomer (e.g., an olefin elastomer, a TPO with polypropylene, a TPO with a copolymer of polypropylene and polyethylene, a TPO with a UV inhibitor, and combinations thereof), and the inner support 114 and the coupling member 116 comprise a second material, such as a polymer or elastomer (e.g., a TPO). Accordingly, the banding apparatus 100 can be co-extruded using a bi-extruder. In some embodiments, the first and second materials are the same.

FIG. 4 illustrates a banding apparatus 200 according to another embodiment of the present invention, wherein like numerals represent like elements. The banding apparatus 200 shares many of the same elements and features described above with reference to the illustrated embodiment of FIGS. 1-2. Accordingly, elements and features corresponding to elements and features in the illustrated embodiment of FIGS. 1-2 are provided with the same reference numerals in the 200 series. Reference is made to the description above accompanying FIGS. 1-2 for a more complete description of the features and elements (and alternatives to such features and elements) of the embodiment illustrated in FIG. 4.

The banding apparatus 200 includes an outer cover 212, an inner support 214, and a coupling member 216, which couples the banding apparatus 200 to a furniture element, such as the furniture element 20 illustrated in FIG. 2. The outer cover 212 and the inner support 214 comprise a first material, such as a polymer or an elastomer (e.g., an olefin elastomer, a TPO with polypropylene, a TPO with a copolymer of polypropylene and polyethylene, a TPO with a UV inhibitor, and combinations thereof), and the coupling member 116 comprises a second material, such as a polymer or an elastomer, (e.g., a TPO). Accordingly, the banding apparatus 200 can be co-extruded using a bi-extruder. In some embodiments, the first and second materials are the same.

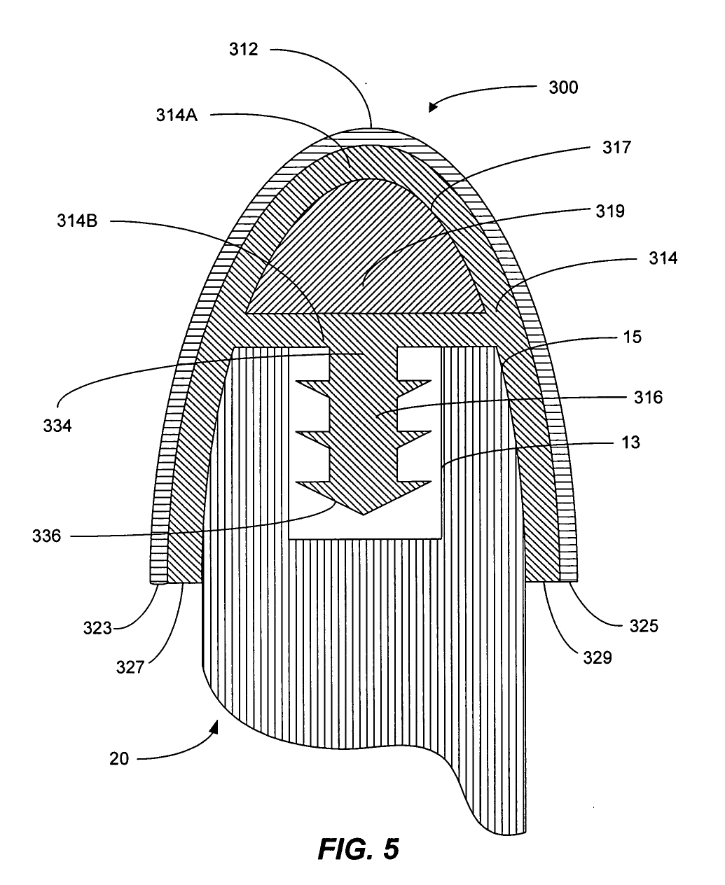

FIG. 5 illustrates a banding apparatus 300 according to another embodiment of the present invention, wherein like numerals represent like elements. The banding apparatus 300 shares many of the same elements and features described above with reference to the illustrated embodiment of FIGS. 1-2. Accordingly, elements and features corresponding to elements and features in the illustrated embodiment of FIGS. 1-2 are provided with the same reference numerals in the 300 series. Reference is made to the description above accompanying FIGS. 1-2 for a more complete description of the features and elements (and alternatives to such features and elements) of the embodiment illustrated in FIG. 5.

The banding apparatus 300 includes an outer cover 312, an inner support 314, and a coupling member 316. In the embodiment illustrated in FIG. 5, the inner support 314 includes a first external portion 314A that is positioned adjacent the outer cover 312, and a second internal portion 314B positioned adjacent the coupling member 316. The first external portion 314A and the second internal portion 314B are spaced apart to define an opening 317.

The outer cover 312 and the inner support 314 can be dimensioned to cover the external surface 15 of a furniture element 20, and the coupling member 316 can be dimensioned to be received within the recess 13 of the furniture element 20. The outer cover 312 includes a first end 323 and a second end 325, and the first external portion 314A of the inner support 314 includes a first end 327 and a second end 329. The coupling member 316 includes a proximal end 334 positioned adjacent the second internal portion 314B of the inner support 314, and a distal end 336 which extends into the recess 13 of the furniture element 20 when the banding apparatus 300 is coupled to the furniture element 20. As shown in FIG. 5, the first ends 323 and 327 and the second ends 325 and 329 of the outer cover 312 and first external portion 314A of the inner support 314, respectively, extend beyond the distal end 336 of the coupling member 316 to cover a greater portion of the external surface 15 of the furniture element 20 (i.e., as compared to the other banding apparatuses 10, 100 and 200 shown in FIGS. 1-4).

In some embodiments, air is injected into the portion of the extrusion die that forms the opening 317 of the banding apparatus 300. Varying amounts of air can be injected to affect the shape of the opening 317 and the shape of the resulting banding apparatus 300.

In some embodiments, as shown in FIG. 5, the banding apparatus 300 includes a core 319 positioned within the opening 317. In some embodiments, the core 319 can be formed of a polymer, particularly, an elastomer, and more particularly, an olefinic elastomer or a thermoplastic olefin elastomer (TPO). In some embodiments, the core 319 is formed of a foamed polymer, i.e., a polymer combined with a chemical foaming agent, also known as a chemical blowing agent. Exothermic and endothermic chemical foaming agents can be used with the present invention. One example of an exothermic foaming agent is azodicarbonamide. In some embodiments, the core 319 includes a combination of a TPO and chemical foaming agent. In some embodiments, the core 319 includes a combination of an olefinic elastomer and a chemical foaming agent. The foaming agent helps to reduce the density of the polymer filler to decrease the density of the resulting banding apparatus 300. For example, in some embodiments, the density of the core 319 formed of a foamed polymer can range from about 0.4 to about 0.6 g/mL, as compared to a density ranging from about 0.7 to about 0.9 g/mL when the core 319 is formed of the same unfoamed polymer.

In the embodiment illustrated in FIG. 5, the inner support 314 and the coupling member 316 are formed of a first material, and the outer cover 312 is formed of a second material. In addition, if employed, the core 319 is formed of a third material. Thus, the banding apparatus 300 can be formed using a tri-extruder, wherein a first portion of the extrusion die forms the inner support 314 and the coupling member 316, a second portion forms the outer cover 312, and a third portion (whether injected with air or a polymer core 319) forms the opening 317. Materials can be introduced into the tri-extruder at different times to optimize the bonding together of the portions of the banding apparatus 300, and the time needed to form.

Even though the inner support 314 and the coupling member 316 are formed of the same material in the embodiment illustrated in FIG. 5, it should be understood that the inner support 314 and the coupling member 316 can be formed of different materials in some embodiments of the invention. For example, the coupling member 316 can be formed of a harder material than the inner support 314. In addition, in some embodiments, the first external portion 314A and the second internal portion 314B of the inner support 314 are formed of two different materials.

Examples relating to the present invention are discussed below. The following examples are intended to be illustrative and not limiting.

### EXAMPLE 1

A banding apparatus 10, as best illustrated in FIGS. 1-2, in which the outer cover 12 comprises an ethylene elastomer. The ethylene elastomer can be formulated to be abrasion and stain resistant, as in a modified ADVANTECH™-brand resin (available from DuPont Corporation).

The inner support 14 and the coupling member 16 comprise a thermoplastic polyolefinic elastomer (TPO). Specifically, the inner support 14 comprises (a) 30% (wt % and vol % are relatively equivalent, because the density of the constituents of the TPO are relatively equal) copolymer polypropylene (i.e., a copolymer of polypropylene and polyethylene), and (b) 70% of ENGAGE®-brand ethylene butene, Grade 7270 (available from Dupont Dow).

The coupling member 16 comprises (a) 40% (wt % and vol % are relatively equivalent, because the density of the constituents of the TPO are relatively equal) copolymer polypropylene, and (b) 60% of ENGAGE®-brand ethylene butene, Grade 7270 (available from Dupont Dow). The 30/70 and 40/60 ratios of copolymer polypropylene to ENGAGE®-brand ethylene butene are described by way of example only. However, this ratio can be varied to meet specific part requirements without departing from the spirit and scope of the present invention.

Each TPO is blended prior to an extrusion process. The ethylene elastomer used to form the outer cover 12, the TPO used to form the inner support 14, and the TPO used to form the coupling member 16 are each fed into an extruder. Approximately 90% of the volume of the starting material is the TPO for the inner support 14 and the coupling member 16. Approximately 10% of the volume of the starting material is the ethylene elastomer for the outer cover 12. Approximately the last 25% of the length of the tri-extruder is used to introduce the three materials together to allow the three materials to become coupled together.

### EXAMPLE 2

A banding apparatus 10, as best illustrated in FIGS. 1-2, in which the outer cover 12 was formed of an ethylene elastomer, specifically, a modified ADVANTECH™-brand resin (available from DuPont Corporation).

The inner support 14 and the coupling member 16 were each formed of a thermoplastic polyolefinic elastomer (TPO). Specifically, the inner support 14 was formed of (a) 50% (wt % and vol % are relatively equivalent, because the density of the constituents of the TPO are relatively equal) copolymer polypropylene (i.e., a copolymer of polypropylene and polyethylene), and (b) 50% of ENGAGE®-brand ethylene butene, Grade 7270 (available from Dupont Dow).

The coupling member 16 was formed of (a) 90% (wt % and vol % are relatively equivalent, because the density of the constituents of the TPO are relatively equal) copolymer polypropylene, and (b) 10% of ENGAGE®-brand ethylene butene, Grade 7270 (available from Dupont Dow).

The resulting banding apparatus 10 had a Shore A Durometer hardness of about 90. This is because the hardness test was conducted with an indenter that strikes the outer cover 12 and inner support 14. The thickness of the outer cover 12 ranged from about 10 to about 15 hundredths of an inch, which was substantially less than that of the inner support 14, so the hardness of the resulting banding apparatus 10 was predominantly determined by the characteristics of the inner support 14. The Shore A Durometer hardness of the copolymer polypropylene is about 100, and the Shore A Durometer hardness of ENGAGE®-brand ethylene butene, Grade 7270 is about 80. As a result, the banding apparatus 10 exhibited a Shore A Durometer hardness of about 90.

### EXAMPLE 3

A banding apparatus 10, as best illustrated in FIGS. 1-2, in which the outer cover 12 was formed of an ethylene elastomer, specifically, a modified ADVANTECH™-brand resin (available from DuPont Corporation).

The inner support 14 and the coupling member 16 were each formed of a thermoplastic polyolefinic elastomer (TPO). Specifically, the inner support 14 was formed of (a) 50% (wt % and vol % are relatively equivalent, because the density of the constituents of the TPO are relatively equal) copolymer polypropylene (i.e., a copolymer of polypropylene and polyethylene), and (b) 50% of ENGAGE®-brand ethylene butene, Grade 8842 (available from Dupont Dow).

The coupling member 16 was formed of (a) 90% (wt % and vol % are relatively equivalent, because the density of the constituents of the TPO are relatively equal) copolymer polypropylene, and (b) 10% of ENGAGE®-brand ethylene butene, Grade 8842 (available from Dupont Dow).

The resulting banding apparatus 10 had a Shore A Durometer hardness of about 72. The Shore A Durometer hardness of the copolymer polypropylene is about 100, and the Shore A Durometer hardness of ENGAGE®-brand ethylene butene, Grade 8842 is about 54. As a result, the banding apparatus 10 exhibited a Shore A Durometer hardness of about 72.

### EXAMPLE 4

A banding apparatus 10, as best illustrated in FIGS. 1-2, in which the outer cover 12 was formed of an ethylene elastomer, specifically, a modified ADVANTECH™-brand resin (available from DuPont Corporation).

The inner support 14 and the coupling member 16 were each formed of a thermoplastic polyolefinic elastomer (TPO). Specifically, the inner support 14 was formed of (a) 30% (wt % and vol % are relatively equivalent, because the density of the constituents of the TPO are relatively equal) copolymer polypropylene (i.e., a copolymer of polypropylene and polyethylene), and (b) 70% of ENGAGE®-brand ethylene butene, Grade 8842 (available from Dupont Dow).

The coupling member 16 was formed of (a) 90% (wt % and vol % are relatively equivalent, because the density of the constituents of the TPO are relatively equal) copolymer polypropylene, and (b) 10% of ENGAGES-brand ethylene butene, Grade 8842 (available from Dupont Dow).

The resulting banding apparatus 10 had a Shore A Durometer hardness of about 67. The Shore A Durometer hardness of the copolymer polypropylene is about 100, and the Shore A Durometer hardness of ENGAGE®-brand ethylene butene, Grade 8842 is about 54. As a result, the banding apparatus 10 exhibited a Shore A Durometer hardness of about 67.

### EXAMPLE 5

A banding apparatus 300, similar to that shown in FIG. 5, in which the outer cover 312 was formed of an ethylene elastomer, specifically, a modified ADVANTECH™-brand resin (available from DuPont Corporation).

The inner support 314 and the coupling member 316 were extruded together and formed of a thermoplastic polyolefinic elastomer (TPO). Specifically, the inner support 314 and the coupling member 316 were formed of (a) 50% (wt % and vol % are relatively equivalent, because the density of the constituents of the TPO are relatively equal) copolymer polypropylene (i.e., a copolymer of polypropylene and polyethylene), and (b) 50% of ENGAGE®-brand ethylene butene, Grade 7270 (available from Dupont Dow).

The banding apparatus 300 was extruded using a tri-extruder in a process similar to that described in Example 1. A first portion of the extruder was used to form the outer cover 312, a second portion of the extruder was used to form the inner support 314 and the coupling member 316, and air was injected into a third portion to form a hollow opening 317 of the banding apparatus 300 between the first external portion 314A and the second internal portion 314B of the inner support 314.

### EXAMPLE 6

A banding apparatus 300 similar to that shown in FIG. 5 was formed according to the materials and process set forth in Example 5, except that a foamed polymer was used in the third portion of the extruder instead of air to form a core 319. Particularly, the core 319 was formed of an ethylene butene elastomer, specifically, ENGAGE®-brand ethylene butene, Grade 7270 (available from Dupont Dow), which was combined with 1% of a foaming agent, namely, azodicarbonamide.

### EXAMPLE 7

A banding apparatus 300 similar to that shown in FIG. 5 was formed according to the materials and process set forth in Example 5, except that a foamed polymer was used in the third portion of the extruder instead of air to form a core 319. Particularly, the core 319 was formed of an ethylene butene elastomer, specifically, ENGAGE®-brand ethylene butene, Grade 7270 (available from Dupont Dow), which was combined with 2% of a foaming agent, namely, azodicarbonamide.

### EXAMPLE 8

A banding apparatus 300 similar to that shown in FIG. 5 was formed according to the materials and process set forth in Example 5, except that a foamed polymer was used in the third portion of the extruder instead of air to form a core 319. Particularly, the core 319 was formed of a thermoplastic olefin elastomer, specifically, a TPO formed of (a) 50% (wt % and vol % are relatively equivalent, because the density of the constituents of the TPO are relatively equal) copolymer polypropylene (i.e., a copolymer of polypropylene and polyethylene), and (b) 50% of ENGAGES-brand ethylene butene, Grade 7270 (available from Dupont Dow). The TPO was combined with 1% of a foaming agent, namely, azodicarbonamide.

Various features and aspects of the invention are set forth in the following claims.

What is claimed is:

1. A banding apparatus for use with a furniture element having a recess and an external surface, the banding apparatus comprising:
a first portion dimensioned to cover the external surface of the furniture element, the first portion comprising a first thermoplastic polyolefin elastomer having a first ratio of a first polyolefin to a first olefinic elastomer; and
a second portion coupled to the first portion and dimensioned to be received within the recess of the furniture element, the second portion comprising a second thermoplastic polyolefin elastomer having a second ratio of a second polyolefin to a second olefinic elastomer, the second ratio being different from the first ratio.

2. The banding apparatus of claim 1, wherein the first polyolefin is the same as the second polyolefin, and the first olefinic elastomer is the same as the second olefinic elastomer.

3. The banding apparatus of claim 1, wherein the second portion includes at least one projection shaped to inhibit removal of the second portion from the recess of the furniture element.

4. The banding apparatus of claim 1, wherein each of the first polyolefin and the second polyolefin includes at least one of ethylene, propylene, butene, pentene, hexene, heptene, octene, and combinations thereof.

5. The banding apparatus of claim 1, wherein each of the first olefinic elastomer and the second olefinic elastomer includes at least one of ethylene-propylene rubber (EPR), ethylene-butene rubber (EBR), ethylene-octene rubber (EOR), ethylene-propylene-diene terpolymer (EPDM), and combinations thereof.

6. The banding apparatus of claim 1, wherein the second ratio is greater than the first ratio.

7. The banding apparatus of claim 6, wherein each of the first ratio and the second ratio is at least about 0.15.

8. The banding apparatus of claim 6, wherein each of the first ratio and the second ratio is less than about 0.55.

9. The banding apparatus of claim 1, wherein the second portion is harder than the first portion.

10. The banding apparatus of claim 1, wherein the first ratio is at least about 0.15, and the second ratio is at least about 0.20.

11. The banding apparatus of claim 1, wherein the first ratio is less than about 0.45, and the second ratio is less than about 0.55.

12. The banding apparatus of claim 1, wherein the first ratio is about 0.30, and the second ratio is about 0.40.

13. The banding apparatus of claim 1, wherein the difference between the first ratio and the second ratio is at least about 0.05.

14. The banding apparatus of claim 1, further comprising a third portion coupled to the first portion opposite the second portion, the third portion dimensioned to cover an external surface of the first portion.

15. The banding apparatus of claim 14, wherein the third portion comprises a third olefinic elastomer.

16. The banding apparatus of claim 15, wherein the first portion is covalently bonded to the second portion and the third portion.

17. The banding apparatus of claim 15, wherein the first polyolefin and the second polyolefin each includes at least one of ethylene, propylene, butene, pentene, hexene, heptene, octene, and combinations thereof, wherein each of the first olefinic elastomer, the second olefinic elastomer, and the third olefinic elastomer includes at least one of ethylene-propylene rubber (EPR), ethylene-butene rubber (EBR), ethylene-octene rubber (EOR), ethylene-propylene-diene terpolymer (EPDM), and combinations thereof.

18. A banding apparatus for use with a furniture element having a recess and an external surface, the banding apparatus comprising:
a first portion dimensioned to cover the external surface of the furniture element, the first portion comprising at least one of an olefinic elastomer and a first thermoplastic olefin elastomer; and
a second portion coupled to the first portion and dimensioned to be received within the recess of the furniture element to couple the banding apparatus to the furniture element, the second portion comprising a second thermoplastic olefin elastomer, the second portion being harder than the first portion.

19. The banding apparatus of claim 18, wherein the first thermoplastic olefin elastomer includes a first ratio of a polyolefin to an olefinic elastomer, wherein the second thermoplastic olefin elastomer includes a second ratio of the polyolefin to the olefinic elastomer, and wherein the second ratio is different from the first ratio.

20. The banding apparatus of claim 18, wherein the first thermoplastic olefin elastomer includes a first ratio of a first polyolefin to a first olefinic elastomer, wherein the second thermoplastic olefin elastomer includes a second ratio of a second polyolefin to a second olefinic elastomer, and wherein the second ratio is greater than the first ratio.

21. The banding apparatus of claim 20, wherein each of the first ratio and the second ratio is at least about 0.15.

22. The banding apparatus of claim 20, wherein each of the first ratio and the second ratio is less than about 0.55.

23. The banding apparatus of claim 18, wherein the first portion is at least one of less stiff, more flexible, more stain resistant, more abrasion resistant, and more impact resistant than the second portion.

24. The banding apparatus of claim 18, wherein the first portion includes an external portion that comprises the olefinic elastomer and an internal portion that comprises the first thermoplastic olefin elastomer, and wherein the external portion is positioned externally with respect to the internal portion when the banding apparatus is coupled to the furniture element.

25. The banding apparatus of claim 18, wherein the olefinic elastomer includes at least one of ethylene-propylene rubber (EPR), ethylene-butene rubber (EBR), ethylene-octene rubber (EOR), ethylene-propylene-diene terpolymer (EPDM), and combinations thereof.

26. A method of manufacturing a banding apparatus for a furniture element, the furniture element having a recess and an external surface, the method comprising:
extruding a first elastomer to form a first portion of the banding apparatus, the first portion adapted to cover the external surface of the furniture element; and
co-extruding a second elastomer with the first elastomer to form a second portion of the banding apparatus, the second portion dimensioned to be received within the recess of the furniture element, the second elastomer being different from the first elastomer.

27. The method of claim 26, wherein the first elastomer comprises an olefinic elastomer, and the second elastomer comprises a thermoplastic olefin elastomer.

28. The method of claim 26, wherein the first elastomer comprises a first thermoplastic olefin elastomer that includes a first ratio of a first polyolefin to a first olefinic elastomer, wherein the second elastomer comprises a second thermoplastic olefin elastomer that includes a second ratio of a second polyolefin to a second olefinic elastomer, and wherein the second ratio is different from the first ratio.

29. The method of claim 28, wherein the second ratio is greater than the first ratio.

30. The method of claim 28, wherein the first polyolefin is the same as the second polyolefin, and the first olefinic elastomer is the same as the second olefinic elastomer.

31. The method of claim 26, wherein the second elastomer is harder than the first elastomer.

32. The method of claim 26, wherein the first elastomer is at least one of less stiff, more flexible, more stain resistant, more abrasion resistant, and more impact resistant than the second elastomer.

33. The method of claim 26, further comprising co-extruding a third elastomer with the first elastomer and the second elastomer to form a third portion of the banding apparatus, the third portion coupled to an external surface of the first portion.

34. The method of claim 33, wherein the first elastomer comprises a first thermoplastic olefin elastomer, the second elastomer comprises a second thermoplastic olefin elastomer, and the third elastomer comprises an olefinic elastomer.
